(19) United States
(12) Patent Application Publication
(10) Pub. No.: US 2008/0205898 A1
(43) Pub. Date: Aug. 28, 2008

(54) Method and device for a flag

(76) Inventor: Nissim Gerby, Cholon (IL)

Correspondence Address: UZI EZRA HAVOSHA & PARTNERS, HADAR-DAFNA HOUSE 39 SHAOUL HAMELECH STREET, TEL AVIV, 64928, omitted

(21) Appl. No.: 11/709,843

(22) Filed: Feb. 23, 2007

(51) Int. Cl. H04B 10/00

(52) U.S. Cl. 398/139

(57) ABSTRACT

A flag that is lit with lights in the body of the flag with the aid of optic fibers. Optionally, the flag can remain outstretched regardless of wind. Optionally, the light shines from behind the material of the flag or between layers of flag material, to reveal patterns or letters cut out in the said flag material and can be seen also in darkness.

### FIELD OF THE INVENTION

This invention is in the field of flags and more particularly a flag with lights that also has the ability to remain outstretched even without wind.

### BACKGROUND OF THE INVENTION

Flags are well known in the art. They are used to announce a message for example that this is the property of that country or that company, or a host nation will honor a guest country with the guest's flag, or an army will raise its flag at an encampment to make it clear who is there.

Flags have a number of disadvantages for example they droop when there is a lack of wind and the face of the flag can not easily be seen. Another disadvantage is that they can not be seen in the dark unless a spotlight is set up to shine onto the flag. This is sometimes ineffective as the flag can be moved by the wind out of the range of the spotlight. This invention reveals a flag that solves these two mentioned problems.

This invention uses optic fibers to transmit the light over a distance while using a light source that could be any type from a battery powered LED light to a mains electricity halogen light. There are many kinds of optic fibers and they can produce different effects like for example only the fiber ends glow or the whole body length of fiber glows, or both.

The fibers themselves are usually very thin and delicate so for practical reasons of protection and for reasons specific to this invention the fiber is contained in a cable that can hold the its shape. When a side glow effect is desired the covering cable will be transparent.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

An object of this invention is for the flag to shine its own light so that it can be seen from a distance especially when dark.

Another object of this invention is for the flag to be able to remain outstretched even without the presence of wind. This could be by using material for the flag that is a firm texture and does not droop like cloth or cloth-like nylon, or this could be achieved by the optic fibers themselves or their surrounding cable being a thick enough material to support the material of the flag, or with the aid of a grid as described below.

Another object of this invention is to have an operating system to control the lights of this invention for example to determine which led lights are on and which are off, and/or a time switch to regulate when the light will shine and/or to create a flashing effect in the lights.

Another object of this invention is to use a low power light source for example LED (light emitting diode) lights to ensure maximum hours of use before changing the battery.

Another object of this invention is to use an efficient medium for the transfer of the said light to distal parts of the flag, an example of such medium could be fiber optics that can carry light long distances in the fiber by rebounding the light waves between its walls where minimal light is lost in the rebound. This fiber would be used for end fiber lighting.

Another object of this invention is to use a source of electrical power to light the lights. This could be for example a battery, a rechargeable battery, solar energy or attachment to mains electricity.

Another object of this invention is to have the optic fibers woven in and out of the material of the flag to produce light effects on both sides of the flag.

Another object of this invention is to have two layers of flag material and the optic fibers being for example stuck between them. In this embodiment there could be holes or other shapes cut out of the material of the flag on one or both sides and the light would shine out of the cut out shapes. Letter shapes could also be used thereby lighting a greeting or other message visible in the day and night.

A grid could be used in the space between the two layers of material to support the flag in a stretched position and/or assist to support the optic fibers possible winding path between the said two layers of the flag.

Another object of this invention is to attach solar panels to the flag or to the pole or other object, to provide a source of energy for the lights.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic depiction of a flag with a LED light and an optical fiber therein.

FIG. 2 is a schematic depiction of a flag with many LED lights and many optic fibers.

FIG. 3 is a schematic depiction of a flag on a support pole where the optic fiber is woven in and out of the material of the flag so that the light in the fiber is visible on both sides of the flag.

FIG. 4 is a schematic depiction of a flag that has two layers of material and the optic fiber rests between the said layers to shine optionally on both sides of the flag depending on the cutting of shapes out of the said material.

FIG. 5 is a schematic depiction of a grid that could be used with the flag of this invention.

FIG. 6 is a schematic depiction of end show optic fibers in a flag.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

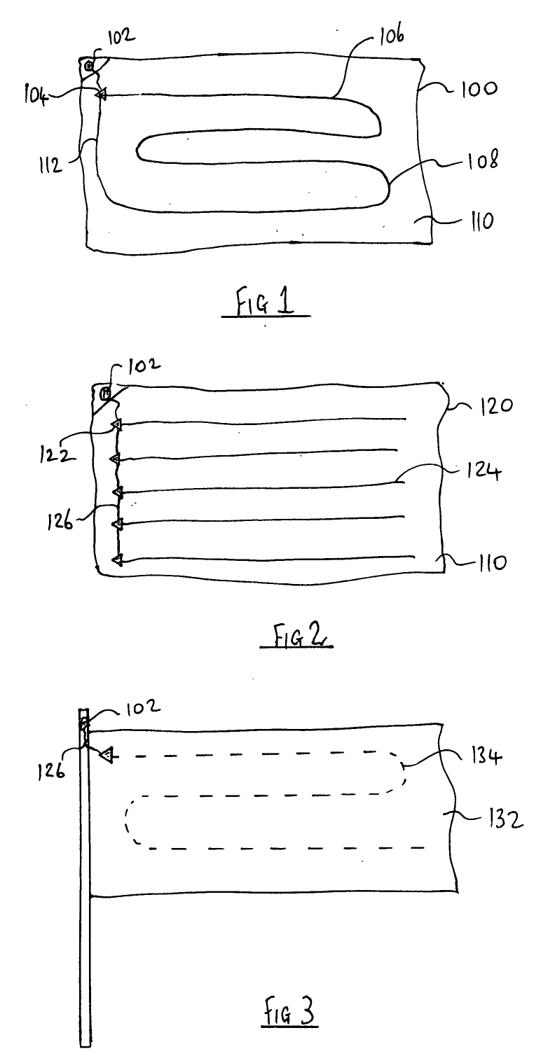

FIG. 1 shows a flag 100 with an electrical power source 102 attached to the flag 100. The source of energy could be for example, a regular battery, re-chargeable battery, a battery charged by a solar panel or a mains or generated electricity connection. The power source would be used for example for lighting the led light 104 that would be attached to or be close to the optic fiber 106. When the light 104 is lit the rays would travel through the fiber 106 all the way to the end including turning the corners 108. The optic fiber 106 could be made of stiffer material or encased in transparent tubing that would support its own shape and support the flag outstretched 110.

The fiber 108 loops back 112 to its energy source to give a more efficient use of the light effect.

The electrical power source 102 could be sewn into the material of the flag 100 or otherwise attached. The LED light 104 and the optic fiber could be also sewn onto or into the material of the flag 100 or otherwise attached.

FIG. 2 shows a flag 120 with a source of energy 102 and more than one light source. All the light sources 122 could be connected by an electric conductor 126. Each light source 122 could have an optic fiber 124 leading from it. Here too, the optic fibers 124 could be made of stiffer material or encased in transparent tubing that would support there own shape and support the flag outstretched 110.

FIG. 3 shows a flag pole 130 supporting the flag 132 and housing the power source 102. The power source 102 is connected by electrical conducting material 126 to a light source for example a led light that is in turn close to or attached to the end of the optic fiber 134. In this embodiment the fiber 134 is woven into the material of the flag 132 so that the light effect will be seen on both sides of the flag. The type of optic fiber used is the side glow kind that enables the light to be seen along its length and not just at its end.

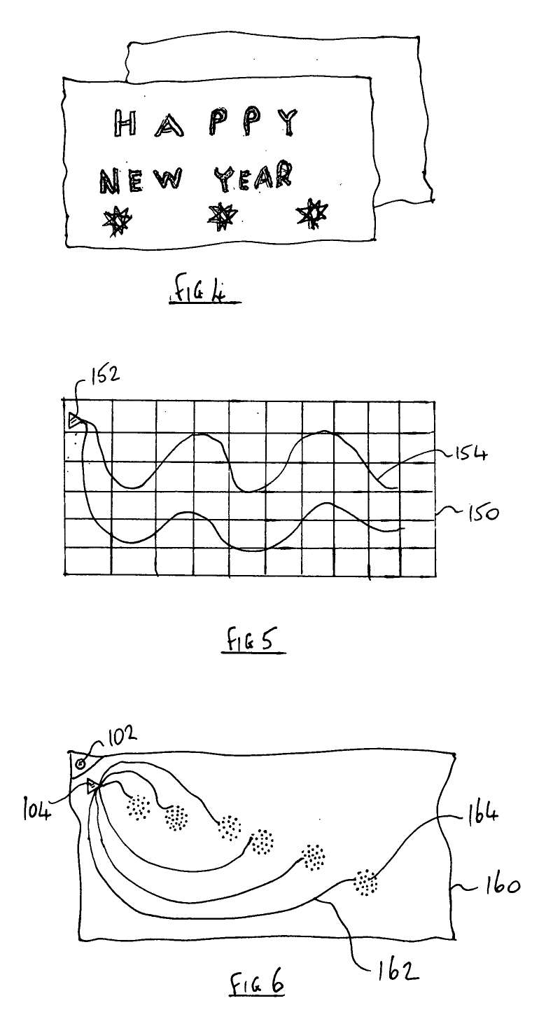

FIG. 4 shows a flag 140 that is made of two layers 142 of material. This enables the optic fibers to be placed between the layers and by cutting shapes 144 or letters 146 out of the material of the flag 140. The patterns or messages would light up on one or both sides of the flag 140.

FIG. 5 shows a grid 150 that could be made of any suitable firm material and could be placed between two layers of a two layer flag FIG. 4. The purpose of the grid would be two fold namely to support the optic fiber 154 thereby enabling the fiber to be made with a thinner cable. A thinner cable would inhibit the light passing through to a lesser extent, be less costly to produce and be more flexible to make sharper twists and turns. The second purpose of the grid is to hold the flag in an outstretched position.

FIG. 6 shows a flag 160 with a source of energy 102 and a source of light 104 with optic fibers in a cable 162 that glow at the extremities 164 of the fiber. This method of transmitting light through the fiber is more efficient than the side-glow method, The strength of the light 164 at the end of the cable 162 is close to the strength at the light source 104. There could be many fibers in a cable 162 producing a multi light effect at the extremity 164. The cable 162 could be hidden between two layers of material of the flag 160 or be made of transparent plastic or be at the back of the flag. This would be so because the cable 162 would not glow as in the case of side glow cables and therefore would be unsightly to be seen.

What is claimed:

1. A method and device for a lit flag comprising,
a) at least one light source,
b) at least one optic fiber, and
c) a source of electrical energy,
whereby a flag can be flown and light be seen from the said flag.

2. A method and device for a lit flag as claimed in claim 1 wherein the said light source is one or more of the following kinds of light source namely, a led light, fluorescent, high-intensity discharge lamps, incandescent bulbs and halogen bulbs.

3. A method and device for a lit flag as claimed in claim 1 wherein the said optic fiber is a side view fiber.

4. A method and device for a lit flag as claimed in claim 1 wherein the said optic fiber is an end view fiber.

5. A method and device for a lit flag as claimed in claim 1 wherein the optic fiber is incorporated in a cable.

6. A method and device for a lit flag as claimed in claim 5 wherein the said cable is wholly or partially transparent.

7. A method and device for a lit flag as claimed in claim 1 wherein the said energy source is at least one of the following sources of energy namely a battery, a rechargeable battery, a solar battery including collector panels, generated electricity from a local generator and mains supply of electricity.

8. A method and device for a lit flag comprising,
a) at least one led light,
b) at least one optic fiber,
c) a source of electrical energy, and
d) a control unit to control the lighting of the said light,
whereby a flag can be flown and light be seen from the said flag.

9. A method and device for a lit flag as claimed in claim 8 wherein the said light source is one or more of the following kinds of light source namely, a led light, fluorescent, high-intensity discharge lamps, incandescent bulbs and halogen bulbs.

10. A method and device for a lit flag as claimed in claim 8 wherein the said optic fiber is a side view fiber.

11. A method and device for a lit flag as claimed in claim 8 wherein the said optic fiber is an end view fiber.

12. A method and device for a lit flag as claimed in claim 8 wherein the optic fiber is incorporated in a cable.

13. A method and device for a lit flag as claimed in claim 12 wherein the said cable is wholly or partially transparent.

14. A method and device for a lit flag as claimed in claim 8 wherein the said energy source is at least one of the following sources of energy namely a battery, a rechargeable battery, a solar battery including collector panels, generated electricity from a local generator and mains supply of electricity.

15. A method and device for a lit flag comprising,
a) at least two layers of material of the flag,
a) at least one light source,
b) at least one optic fiber,
c) a source of electrical energy, and
d) a control unit to control the lighting of the said light,
whereby a flag can be flown and light be seen from the said flag.

16. A method and device for a lit flag as claimed in claim 15 further comprising a grid attached between the said two layers of material to support the said flag outstretched and to support the said optic fiber.

17. A method and device for a lit flag as claimed in claim 15 wherein the said light source is one or more of the following kinds of light source namely, a led light, fluorescent, high-intensity discharge lamps, incandescent bulbs and halogen bulbs.

18. A method and device for a lit flag as claimed in claim 15 wherein the said optic fiber is a side view fiber.

19. A method and device for a lit flag as claimed in claim 15 wherein the said optic fiber is an end view fiber.

20. A method and device for a lit flag as claimed in claim 15 wherein the optic fiber is incorporated in a cable.

21. A method and device for a lit flag as claimed in claim 20 wherein the said cable is wholly or partially transparent.

22. A method and device for a lit flag as claimed in claim 15 wherein the said energy source is at least one of the following sources of energy namely a battery, a rechargeable battery, a solar battery including collector panels, generated electricity from a local generator and mains supply of electricity.
